(19) United States
(12) Patent Application Publication
(10) Pub. No.: US 2015/0029306 A1
(43) Pub. Date: Jan. 29, 2015

(54) METHOD AND APPARATUS FOR STABILIZING PANORAMA VIDEO CAPTURED BASED ON MULTI-CAMERA PLATFORM

(71) Applicants: Natural University of Sciences & Technology(NUST), Islamabad (PK); Electronics and Telecommunications Research Institute, Daejeon-si (KR)

(72) Inventors: Yong Ju CHO, Seoul (KR); Seong Yong LIM, Daejeon-si (KR); Joo Myoung SEOK, Daejeon-si (KR); Myung Seok KI, Daejeon-si (KR); Ji Hun CHA, Daejeon-si (KR); Rehan HAFIZ, Islamabad (PK); Muhammad Murtaza KHAN, Islamabad (PK); Ameer HAMZA, Islamabad (PK); Arshad ALI, Islamabad (PK)

(73) Assignees: Natural University of Sciences & Technology(NUST), Islamabad (PK); Electronics and Telecommunications Research Institute, Daejeon-si (KR)

(21) Appl. No.: 14/044,405

(22) Filed: Oct. 2, 2013

(30) Foreign Application Priority Data
Jul. 24, 2013 (KR) 10-2013-0087169

(51) Int. Cl. H04N 5/232

(52) U.S. Cl. CPC H04N 5/23267; H04N 5/23238
USPC 348/38

(57) ABSTRACT

The present invention proposes a method and apparatus for correcting a motion of panorama video captured by a plurality of cameras. The method of the present invention includes performing global motion estimation for estimating smooth motion trajectories from the panorama video, performing global motion correction for correcting a motion in each frame of the estimated smooth motion trajectories, performing local motion correction for correcting a motion of each of the plurality of cameras for the results in which the motions have been corrected, and performing warping on the results on which the local motion correction has been performed.

Priority to Korean patent application number 10-2013-0087169 filed on Jul. 24, 2013, the entire disclosure of which is incorporated by reference herein, is claimed.

### BACKGROUND OF THE INVENTION

1. Field of the Invention

The present invention relates to the stabilization of panorama video and, more particularly, to the correction of multi-camera video having a motion.

2. Discussion of the Related Art

Panorama video can be obtained by the stitching of images of multiple cameras. In the panorama video, frames are photographed by the multiple cameras, and the frames are stitched in order to form the panorama video. Here, shaking or motions can be generated in the panorama images captured by the multiple cameras. The multiple cameras can be independently moved upward, downward, left, and right. In particular, video captured in a mobile platform is sensitive to a high-frequency jitter, and it may cause inconvenience visually.

More particularly, the following three effects can be generated due to a motion of a camera rig or a platform.

First, the entire panorama exhibition can be shaken. An overall motion can influence the complete frames of stitched images. This is also called frame-shaking.

Second, inter-camera shaking can cause a very inconvenient local jitter in sub-frames of an image. This is also called sub-frame shaking.

Third, objects in different depth surfaces can be shaken due to a parallax. This is also called local shaking attributable to a parallax.

This specification proposes a multi-camera motion correction method and apparatus. In particular, a motion of each camera is corrected as well as a motion of panorama video when generating the panorama video using a plurality of moving cameras.

### SUMMARY OF THE INVENTION

An object of the present invention is to provide an apparatus and method for correcting a motion of panorama video.

Another object of the present invention is to provide a method and apparatus for correcting motions of images of multiple cameras when the plurality of cameras is independently moved.

In accordance with an aspect of the present invention, a method of correcting a motion of panorama video captured by a plurality of cameras includes a global motion trajectory estimation module for performing global motion estimation for estimating smooth motion trajectories from the panorama video, a global motion trajectory application module for performing global motion correction for correcting a motion in each frame of the estimated smooth motion trajectories, a sub-frame correction module for performing local motion correction for correcting a motion of each of the plurality of cameras for results for which the motions have been corrected, and performing warping on results on which the local motion correction has been performed.

In accordance with another aspect of the present invention, an apparatus for correcting a motion of panorama video captured by a plurality of cameras includes a global motion trajectory estimation module for performing global motion estimation for estimating smooth motion trajectories from the panorama video, a global motion trajectory application module for performing global motion correction for correcting a motion in each frame of the estimated smooth motion trajectories, a sub-frame correction module for performing local motion correction for correcting a motion of each of the plurality of cameras on the results in which the motions have been corrected, and a warping module for performing warping on results in which the motions of the plurality of cameras have been corrected.

### BRIEF DESCRIPTION OF THE DRAWINGS

FIG. 1 is a flowchart illustrating an example of a method of correcting a motion of panorama video according to the present invention;

FIG. 2 is a diagram showing a global motion estimation process according to the present invention;

FIG. 3 shows an example of global motion correction according to the present invention;

FIG. 4 shows an example of a blending mask when panorama video includes images of three cameras according to the present invention;

FIG. 5 is a diagram showing that the locations of features are changed through local motion correction according to the present invention;

FIGS. 6A and 6B are diagrams showing the locations of motion-corrected features according to the present invention; and

FIG. 7 is a block diagram showing an example of a motion correction apparatus for panorama video according to the present invention.

### DETAILED DESCRIPTION OF THE EMBODIMENTS

Hereinafter, some embodiments of the present invention are described in detail with reference to the accompanying drawings in order for a person having ordinary skill in the art to which the present invention pertains to be able to readily implement the present invention. It is to be noted that the present invention may be implemented in various ways and is not limited to the following embodiments. Furthermore, in the drawings, parts not related to the present invention are omitted in order to clarify the present invention, and the same or similar reference numerals are used to denote the same or similar elements.

The objects and effects of the present invention can be naturally understood or become clearer by the following description, and the objects and effects of the present invention are not restricted by the following description only.

The objects, characteristics, and merits of the present invention will become more apparent from the following detailed description. Furthermore, in describing the present invention, a detailed description of a known art related to the present invention will be omitted if it is deemed to make the gist of the present invention unnecessarily vague. Some exemplary embodiments of the present invention are described in detail with reference to the accompanying drawings.

Terms used in this specification are described below.

‘Video stabilization’ refers to the discard of an unintended (or unwanted) motion from images captured by moving video cameras.

‘Wide FOV panorama videos’ are captured and stitched by an array of cameras that are fixed to a platform (or camera rig). The camera rig can be moving or static.

An ‘intended motion’ is a motion (i.e., actual and desired movement) actually necessary for a camera rig. An intended motion is a low-frequency component of the entire motion, and it needs to be preserved.

An ‘unintended motion’ is an unintended motion of a camera. An unintended motion is a high-frequency component of the entire motion, and it needs to be discarded.

A ‘moving camera rig’ can produce an unintended motion. For example, the unintended motion can include vibrations/trembling or inter-camera shaking in a camera rig. Here, inter-camera shaking refers to vibrations/trembling between individual cameras. Part of panorama video is moved independently from the remaining parts due to the inter-camera shaking.

‘Jitter/trembling/shaking’ refers to an unintended high-frequency motion, and it is to be most discarded in the present invention.

A ‘sub-frame’ refers to part of a frame taken from panorama video that has been captured by a single camera.

‘Smoothing’ refers to a procedure for fitting a polynomial model or a procedure for filtering feature trajectories through smoothed trajectories.

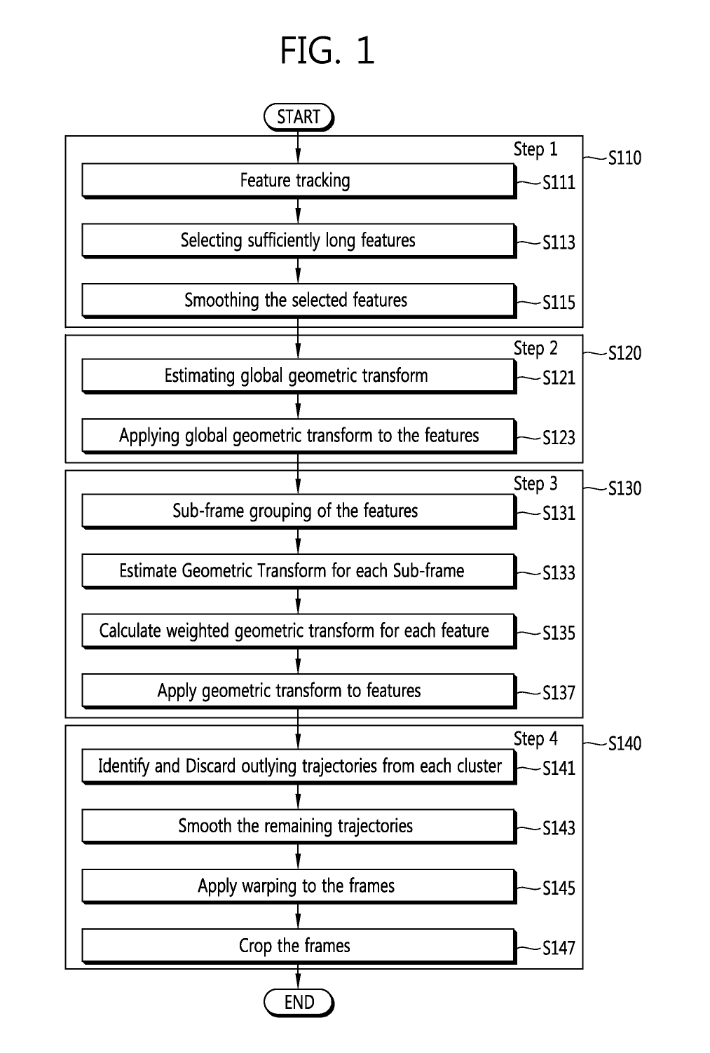

FIG. 1 is a flowchart illustrating an example of a method of correcting a motion of panorama video according to the present invention. When a sequence of panorama video frames is received, a motion correction apparatus generates a Blending Mask (BM) for configuring panorama video when generating a panorama.

Referring to FIG. 1, the method of correcting a motion of panorama video according to the present invention includes step 1 to step 4, that is, steps S110 to S140. More particularly, S110 includes S111, S113, and S115, S120 includes S121 and S123, S130 includes S131, S133, S135, and S137, and S140 includes S141, S143, S145, and S147.

<Step 1>

The motion correction apparatus performs a global motion estimation process of estimating smooth motion trajectories from panorama video at step S110. That is, the motion correction apparatus estimates smooth motion trajectories from the original motion trajectories.

More particularly, the global motion estimation process can include tracking features at step S111, selecting sufficiently long features at step S113, and smoothing the selected features at step S115. Here, selecting the sufficiently long features can include selecting a feature having a length longer than a specific length.

For example, a Kanade-Lucas-Tomasi (KLT) scheme can be used to select the features.

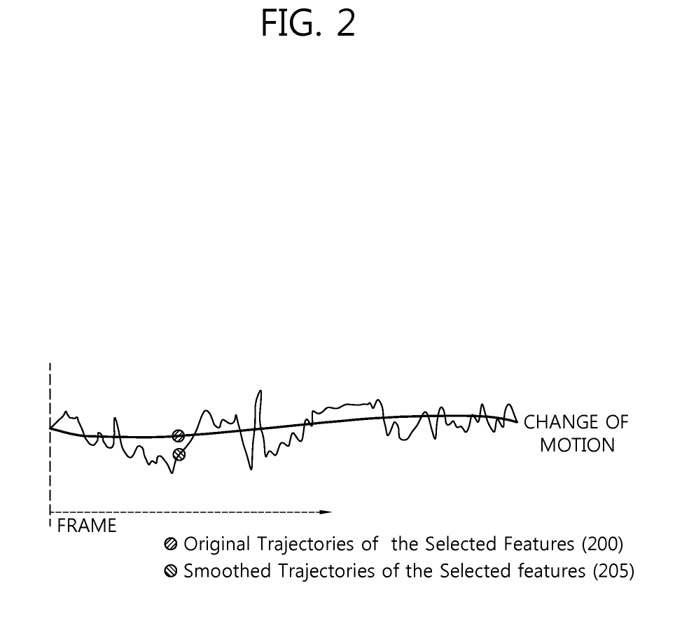

FIG. 2 is a diagram showing the global motion estimation process according to the present invention.

Referring to FIG. 2, a change of a motion in the sequence of received panorama video frames is estimated, and a change of the motion is estimated as frames proceed. Smoothed trajectories 205 of selected features are estimated from original trajectories 200 of the selected features.

For example, the panorama video frames are grouped in terms of overlapping windows including a constant number of video frames. In each overlapping window, a constant number of features are tracked through panorama frames regarding 2-D pixel locations that are called feature trajectories. The selected feature trajectories become smooth by discarding untended high-frequency motions from the selected feature trajectories.

<Step 2>

After step S110, the motion correction apparatus performs a global motion correction process on each frame at step S120. The global motion correction is also called global motion modification or global motion trajectory application.

More particularly, the global motion correction process can include estimating global geometric transform at step S121 and applying the global geometric transform to the features at step S123.

For example, global geometric transform for each frame can be estimated by applying a RANdom SAmpling Consensus (RANSAC) scheme to the original feature trajectories and the smoothed feature trajectories, and the feature trajectories can be globally corrected by applying the global geometric transform (e.g., estimated similarity transform) to the locations of the original feature trajectories.

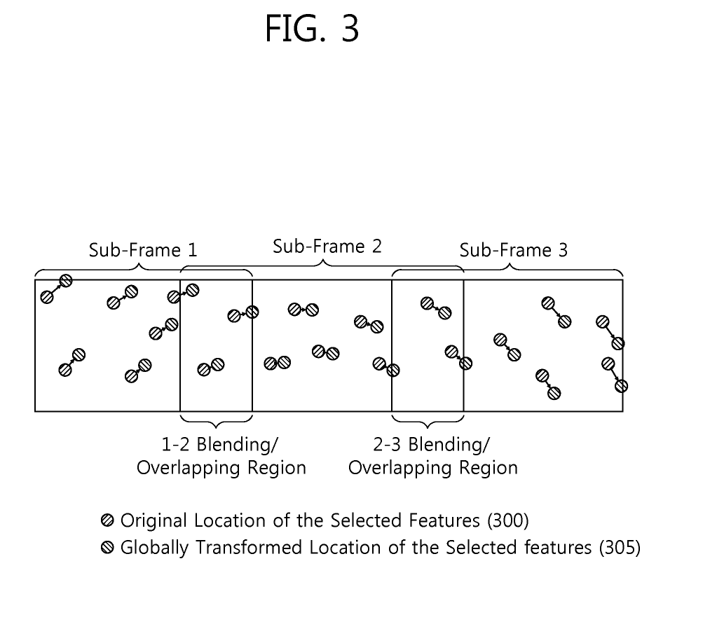

FIG. 3 shows an example of the global motion correction process according to the present invention.

Referring to FIG. 3, reference numeral 300 indicates original locations 300 of selected features prior to global motion correction, and 305 indicates globally transformed locations 305 of the selected features after the global motion correction. Furthermore, a ‘1-2 blending/overlapping region’ is present between a sub-frame 1 and a sub-frame 2, and a ‘2-3 blending/overlapping region’ is present between the sub-frame 2 and a sub-frame 3.

A motion common to a plurality of cameras can be corrected through global motion correction.

<Step 3>

After step S120, the motion correction apparatus performs a local motion correction process of correcting a motion of each camera image at step S130. The local motion correction is also called sub-frame correction. In the local motion correction process, independent shaking of each camera is corrected in relation to the results of corrected global shaking.

More particularly, the local motion correction process include grouping the sub-frames of the features at step S131, estimating geometric transform for each sub-frame at step S133, calculating weighted geometric transform for each feature at step S135, and applying the geometric transforms to the features at step S137.

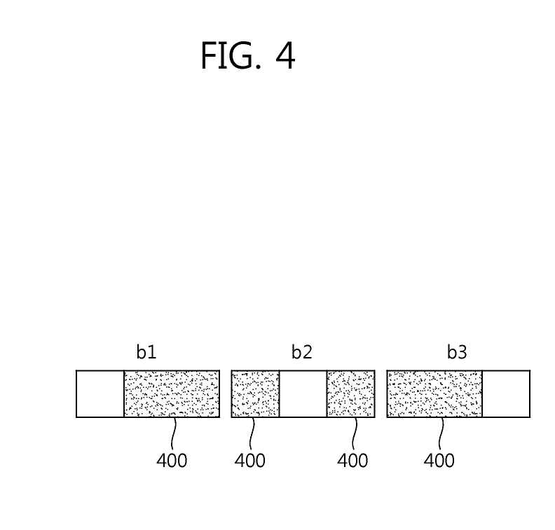

FIG. 4 shows an example of a blending mask when panorama video includes images of three cameras according to the present invention. The panorama video can be generated using n (n is an integer) received camera images. In the example of FIG. 4, the number of camera images is 3.

Referring to FIG. 4, the panorama video includes a location and blending mask for each received image because the panorama video is generated using the 3 received images.

For local motion correction for each camera, changes in the motions of features located at each camera image within the panorama video are analyzed, and smoothed trajectories are calculated and applied. For example, location transform can be performed on the features. Here, local transform matrices can be calculated using the RANSAC scheme, and location transform can be performed on the features using n local transform matrices.

For example, if the RANSAC scheme is used in the original feature trajectories and the smoothed feature trajectories, geometric transform (e.g., affined transform and similarity transform) for each sub-frame of each frame can be estimated. Accordingly, the trajectories of the globally corrected features can be smoothed once more.

The locations of the features within the overlapping region 400 are not aligned because the locations of features present in each camera image part within the panorama video have been independently transformed. That is, the features located in the overlapping region 400 are the same features present in a left image and a right image. Accordingly, seamless panorama video can be configured when the features located in the overlapping region are aligned.

To this end, the locations of the features within the overlapping region 400 can be aligned through Equation 1 below.

h(x,y)=h₁b₁(x,y)+h₂b₂(x,y)+ . . . +hₙbₙ(x,y) [Equation 1]

In Equation 1, h(x,y) is a geometric transform matrix for (x,y), that is, pixel coordinates including a feature. hₙ is estimated geometric transform for a sub-frame n. bₙ(x,y) is a normalized weight value for the pixel coordinates (x,y) for the sub-frame n.

Referring to Equation 1, the locations of all features in a non-overlapping region and an overlapping region are changed according to a property (e.g., weight function in the overlapping region) of a blending mask, but the locations of the features in the overlapping region can be aligned. That is, newly weighted geometric transform for the location of each feature can be calculated as in Equation 1 in the entire panorama video using the property of a blending mask in which the sum of all the blending masks for each pixel is always ‘1’.

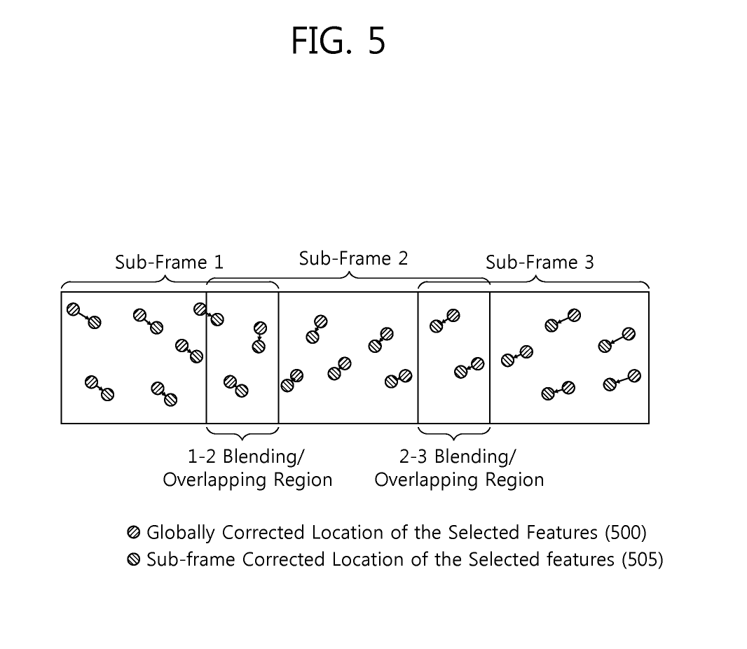

FIG. 5 is a diagram showing that the locations of features are changed through local motion correction according to the present invention.

Referring to FIG. 5, selected features have sub-frame-corrected locations 505 when transform matrices obtained according to Equation 1 are applied to locations 500 of the selected features on which global motion correction has been performed. That is, the sub-frame-corrected locations 505 of the selected features are locations on which both global motion correction and local motion correction have been performed.

Here, weighted transform for all the features placed in a region in which sub-frames do not overlap with each other is the same as the estimated geometric transform hₙ for the frame, which has been proposed in Equation 1.

<Step 4>

After step S130, the motion correction apparatus performs a warping process based on parallax correction at step S140. The warping is also called distortion, twist, or bending.

The warping process includes identifying and discarding trajectories outlying from each cluster at step S141, smoothing the remaining trajectories at step S143, applying warping to the frames at step S145, and cropping the frames at step S147.

All the sub-frame-corrected features are clustered in terms of the locations of features in the first panorama frame of a filter window. Here, a mixture model, that is, a motion model of features placed in each cluster, can be estimated. Furthermore, a probability that each feature trajectory will be placed in the motion model of each cluster can be calculated.

For example, if a probability that each feature trajectory will be placed in the motion model of each cluster is lower than a specific probability (p%), the feature trajectory is not selected and a probability for the feature trajectory is no longer calculated.

For another example, in order to discard unintended motions of the remaining feature trajectories which are related to a high frequency, the remaining feature trajectories can pass through a low-pass filter, or the remaining feature trajectories can be fit to a polynomial model indicative of a motion route necessary for a camera under condition that the motion route necessary for the camera is sufficiently close to the original motion route of the camera. Here, a ‘difference between the original feature trajectory and a discarded feature trajectory’ and a ‘smoothed feature trajectory’ are taken into consideration as an important set.

Meanwhile, in the global motion correction and the local motion correction, a feature inconducive to motion correction (this feature is also called an outlier) may be present. In this case, corresponding features can be discarded by grouping (or clustering) all features into a specific number of groups and discarding a feature having a specially different trajectory from each group. For example, the grouping can include grouping features into 10 groups.

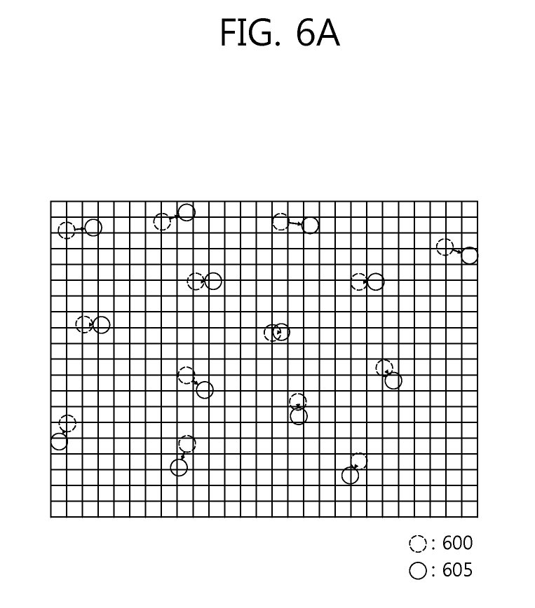

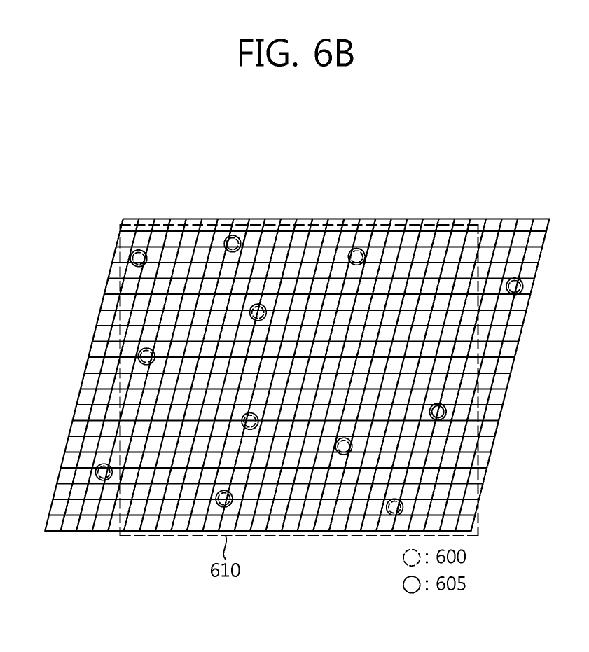

FIGS. 6A and 6B are diagrams showing the locations of motion-corrected features according to the present invention.

FIG. 6A is a diagram showing the original frames together with control points. In FIG. 6A, ‘600’ indicates the locations of features extracted from the original panorama video, and ‘605’ indicates the locations of features to which both the global motion correction and the local motion correction (or location transform) have been applied.

Referring to FIG. 6A, the remaining features from which outliers have been excluded become smooth once more by applying a low-pass filter or a polynomial model to the remaining features. In this case, there is an effect on a feature having a severe motion even after local motion correction.

FIG. 6B shows the results in which both the global motion correction and the local motion correction have been applied. In FIG. 6B, ‘610’ indicates regions in which unnecessary parts generated due to warping are cropped.

The locations of features extracted by warping the original panorama video and the locations of features to which both the global motion correction and the local motion correction have been applied are aligned. A Moving Least Squares Deformation (MLSD) scheme can be used for the location alignment.

Depth information about objects within panorama video can be incorporated through the warping process on the panorama video, and an error of a parallax can be prevented.

Furthermore, if the final set of selected trajectories and a pair of smoothed trajectories are used as control points for warping, new frames are rendered. Cropping can be necessary for the warping, and an empty area can appear near an image that finalizes the rendering of newly stabilized frames.

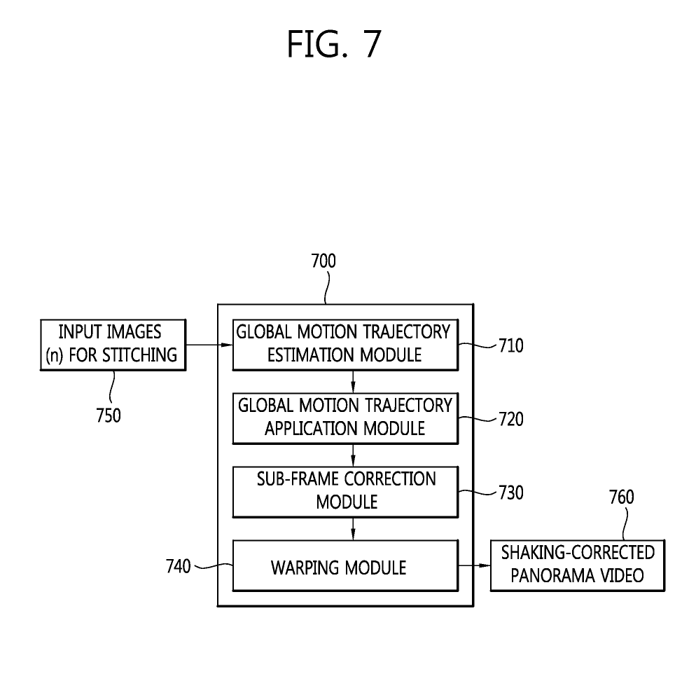

FIG. 7 is a block diagram showing an example of the motion correction apparatus 700 for panorama video according to the present invention. When input images 750 for stitching are received, the motion correction apparatus 700 outputs shaking-corrected panorama video 760.

Referring to FIG. 7, the motion correction apparatus 700 can include at least one of a global motion trajectory estimation module 710, a global motion trajectory application module 720, a sub-frame correction module 730, and a warping module 740. Each of the modules can be formed of a separate unit, and the unit can be included in a processor.

The global motion trajectory estimation module 710 performs global motion estimation for estimating smooth motion trajectories from panorama video. That is, the global motion trajectory estimation module 710 estimates the smooth motion trajectories from the original motion trajectories.

More particularly, the global motion trajectory estimation module 710 can track features, select sufficiently long features from the features, and smooth the selected long features.

For example, the global motion trajectory estimation module 710 can select features using the KLT scheme.

The global motion trajectory application module 720 performs global motion correction on each frame.

More particularly, the global motion trajectory application module 720 can estimate global geometric transform for each frame and apply the global geometric transform to features.

For example, the global motion trajectory application module 720 can estimate global geometric transform for each frame by applying the RANSAC scheme to the original feature trajectories and the smoothed feature trajectories and globally correct the feature trajectories by applying the global geometric transform (e.g., estimated similarity transform) to the locations of the original feature trajectories.

The sub-frame correction module 730 performs local motion correction for correcting a motion of each camera image. That is, the sub-frame correction module 730 corrects independent shaking of each camera for the results in which global shaking has been corrected.

The sub-frame correction module 730 can group the sub-frames of the features, estimate geometric transform for each sub-frame, calculate weighted geometric transform for each feature, and apply the weighted geometric transform to the features.

The warping module 740 performs warping for correcting a parallax.

The warping module 740 can identify or discard trajectories outlying from each cluster, smooth the remaining trajectories, apply warping to the frames, and crop the frame.

In accordance with the present invention, when generating panorama video using multiple camera images, a motion of the panorama video can be discarded by taking independent motions of the cameras into consideration.

A person having ordinary skill in the art to which the present invention pertains may change and modify the embodiments of the present invention in various ways without departing from the technical spirit of the present invention. Accordingly, the present invention is not limited to the aforementioned embodiments and the accompanying drawings.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

What is claimed is:

1. A method of correcting a motion of panorama video captured by a plurality of cameras, the method comprising:
performing global motion estimation for estimating smooth motion trajectories from the panorama video;
performing global motion correction for correcting a motion in each frame of the estimated smooth motion trajectories;
performing local motion correction for correcting a motion of each of the plurality of cameras for results in which the motions have been corrected; and
performing warping on results on which the local motion correction has been performed.

2. The method of claim 1, wherein performing the global motion estimation comprises:
tracking one or more features from the panorama video;
selecting features, each having a length longer than a specific length, from the tracked one or more features; and
smoothing the selected features.

3. The method of claim 2, wherein selecting the features comprises selecting the features using a Kanade-Lucas-Tomasi (KLT) scheme.

4. The method of claim 2, wherein performing the global motion correction comprises:
estimating global geometric transform for each frame; and
applying the estimated global geometric transform to the one or more features.

5. The method of claim 4, wherein estimating the global geometric transform comprises applying a RANdom SAmpling Consensus (RANSAC) scheme to original feature trajectories and smoothed feature trajectories for the one or more features.

6. The method of claim 2, wherein performing the local motion correction comprises:
grouping sub-frames of the one or more features;
estimating geometric transform for each group of the sub-frames;
calculating weighted geometric transform for each of the one or more features; and
applying the estimated geometric transform to the one or more features.

7. The method of claim 1, wherein performing the warping comprises:
identifying or discarding trajectories outlying from each cluster, from among trajectories for one or more features;
smoothing trajectories of one or more features not identified or discarded;
applying the warping to each of the frames; and
cropping the frames.

8. An apparatus for correcting a motion of panorama video captured by a plurality of cameras, the apparatus comprising:
a global motion trajectory estimation module for performing global motion estimation for estimating smooth motion trajectories from the panorama video;
a global motion trajectory application module for performing global motion correction for correcting a motion in each frame of the estimated smooth motion trajectories;
a sub-frame correction module for performing local motion correction for correcting a motion of each of the plurality of cameras on the results in which the motions have been corrected; and
a warping module for performing warping on results in which the motions of the plurality of cameras have been corrected.
